(19) United States
(12) Patent Application Publication
(10) Pub. No.: US 2021/0055703 A1
(43) Pub. Date: Feb. 25, 2021

(54) WIRELESS INTERNET SPRINKLER SYSTEM WITH AUTOMATIC POWER CHARGE

(71) Applicant: Haksoo Kim, San Diego, CA (US)

(72) Inventor: Haksoo Kim, San Diego, CA (US)

(21) Appl. No.: 16/054,991

(22) Filed: Aug. 3, 2018

(51) Int. Cl. G05B 19/042; H04L 29/08; B05B 12/00; A01G 25/16

(52) U.S. Cl. CPC G05B 19/042; H04L 67/125; G05B 2219/2625; A01G 25/167; B05B 12/004

(57) ABSTRACT

This invention is a sprinkler system having a wireless internet module and Host Internet Controller that can be controlled via internet without interruption of power supply due to automatic energy charge in case of insufficient power shortage.

### FIELD OF INVENTION

This invention is a sprinkler system that can be installed at the inside of a sprinkler system with wireless internet device. The sprinkler system can be saved electric energy in the battery. Thus, the sprinkler system can be operated by a host internet controller through a wireless Internet module without interruption of sprinkler system due to lack of power.

### BACKGROUND OF INVENTION

When an existing sprinkler system malfunctions, water is not supplied and then grass gets dry or water wastes too much. If a sprinkler system cannot properly function, it may take time and money to repair the sprinkler system. In addition, sometimes sprinkler system does not operate during power outage due to lack of power, thus glass can be damaged. This invention is devised to solve said problems.

### SUMMARY OF INVENTION

In order to solve these problems, present invention is a sprinkler system having a CPU to check any conditions of sprinkler system with sensors and then the CPU sends date received from sensors via Internet wireless module to Host Internet Controller. The Host Internet Controller makes an order to CPU via Internet Wireless Module.

Moreover, this sprinkler system transforms water flow to electric energy to charge the battery. Thus, sprinkler system can be permanently used without interruption due to lack of power.

This invention also has a temperature sensor which orders the controller to supply more or less water during hot or cold weather. Furthermore, the humidity sensor helps to save water by blocking or supplying the water upon weather humidity condition.

The speed sensor on generator shaft helps identify the sprinkler speed condition. CPU checks an abnormal number of rotation and then CPU controls water supply.

When CPU does not receive an insufficient power saving signal during certain amount of time, the CPU can use power system to check the power saving and then CPU instructs to be charged battery power.

This sprinkler system can be used with Low Power Wireless Module (Bluetooth, ZeeBee or WI-FI) and it can be connected to Internet or cell phone. Thus, this would allow user to monitor the sprinkler system in a more remote way.

### BRIEF DESCRIPTION OF THE DRAWINGS

FIG. 1 illustrates a block diagram of this invention.

FIG. 2 illustrates a Logic block diagram of this invention.

### DETAILED DESCRIPTION OF EMBODIMENTS

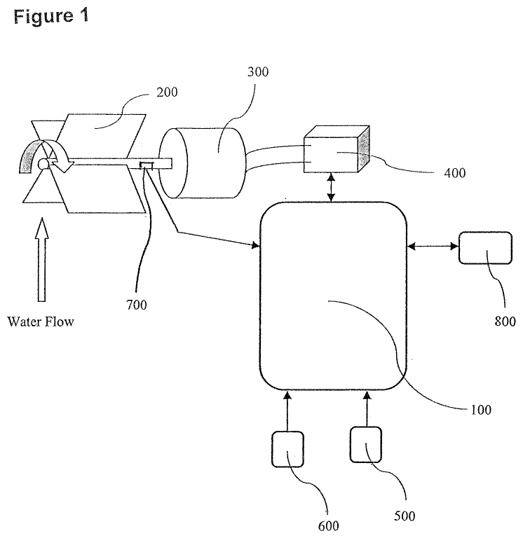

Referring to the invention, in FIG. 1 CPU 101 receives the water flow data in Wheel 200. And CPU 101 checks a power saving condition of Power Regulator & Charger 102. When Power in Power Regulator & Charger 102 is insufficient, CPU 101 sends the power saving data to Host Internet Controller 800 via Wireless Internet Module 103. After that, Host Internet Controller 800 instructs an order to CPU 101 to save the power via Wireless Internet Module 103.

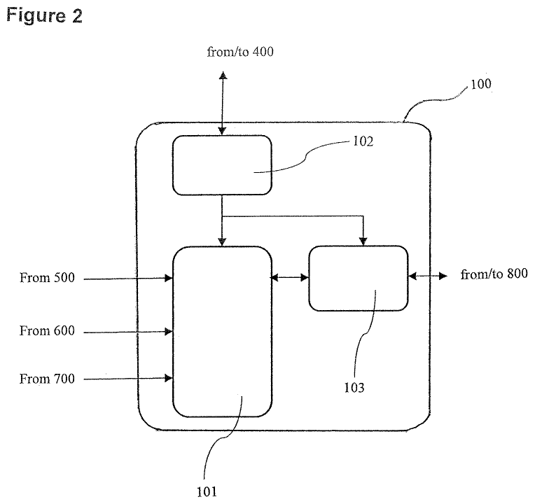

Referring to the invention, in FIG. 2 Logics 100 is comprised of CPU 101, Power Regulator & Changer 102 and Wireless Internet Module 103. The power from Battery 400 is stabilized through Power Regulator & Charger 102 by CPU 101. When power in Power Regulator & Changer 102 is in shortage, CPU 101 delivers data to Host Internet Controller 800 via Wireless Internet Module 103. Host Internet Controller 800 makes direction to CPU 101 via Internet Wireless Module 103 to save power in Battery 400.

CPU 101 saves information collected from various sensors 500, 600, 700 and CPU 101 sends the information through Wireless Internet Module 103 to Host Internet Controller 800. Host Internet Controller 800 makes order to be controlled through Host Internet Controller 800 to CPU 101.

CPU 101 collects temperature data from Temperature Sensor 500 and conveys the data to Host Internet Controller 800 via Wireless Module 103. Host Internet Controller 800 checks the data from CPU 101 and then instructs to CPU 101 to control to supply more or less water for certain duration.

CPU 101 collects humidity data from Humidity Sensor 600 and delivers the data into Internet Host controller 800 through Wireless Internet Module 103. Host Internet Controller 800 receives the data and then instructs to CPU 101 to control water by controlling the water in a rainy or dry day.

CPU 101 collects speed data from Speed Sensor 700 attached to Generator 300 and passes the data to Host Internet Controller 800 via Wireless Internet Module 103. Host Internet Controller 800 receives the data of a condition. CPU 101 checks an abnormal rotation status at a malfunctioning condition of sprinkler system. When Wheel 200 does not properly rotate, CPU 101 verifies that water is not supplied properly. CPU 101 sends data to Host Internet Controller 800 via Wireless Module 103. And then Host Internet Controller 800 instructs order to CPU 101 via Wireless Module 103 to properly rotate the Wheel 200.

This sprinkler system can be used with Low Power Wireless Module (Bluetooth, ZeeBee or WI-FI) and it can be connected to Internet or cell phone. This would allow user to monitor a sprinkler system in a more remote way.

As described above, the specifications contain in full detail the working examples of sprinkler system with Wireless Module 103 and Host Internet Controller 800. This invention, however, is not limited to the aforementioned working examples, and of course, is available for those who have conventional knowledge corresponding to within the idea of this invention. In addition, scope of the right in this invention can be interpreted only in accordance with the scope of patent claim as listed below.

1. Wireless Internet connection Sprinkler System is composed of:
Wheel;
Generator;
Battery;
Sensors;
CPU;
Wireless Internet Module;
Power Regulator & Charger; and
Host Internet Controller.

2. In above claim Paragraph 1, the sprinkler system changes water flow to electric energy to charge the battery.

3. In above claim Paragraph 1, Logics is comprised of CPU, Power Regulator & Changer and Wireless Internet device.

4. A method for wireless Internet connection sprinkler system, comprising, the steps of:
Step of checking malfunctioning when received abnormal data from sensors;
Step of saving power energy when power is in shortage;
Step of transferring data from CPU to Host Internet Controller via wireless internet device; and
Step of controlling from Host Internet Controller for functioning.
